(19) United States
(12) Patent Application Publication
(10) Pub. No.: US 2015/0064336 A1
(43) Pub. Date: Mar. 5, 2015

(54) GRANULAR MATERIAL AND METHOD FOR PRODUCING SAME, AND FOOD, FORAGE AND EDIBLE MEAT PRODUCT EMPLOYING SAME

(71) Applicant: J-OIL MILLS, INC., Tokyo (JP)

(72) Inventors: Junpei Kubota, Tokyo (JP); Kazuya Yokoishi, Tokyo (JP); Isao Kobayashi, Tokyo (JP); Masaru Goto, Tokyo (JP)

(21) Appl. No.: 14/390,080

(22) PCT Filed: Feb. 26, 2013
(86) PCT No.: PCT/JP2013/054858

§ 371 Date: Oct. 2, 2014

(30) Foreign Application Priority Data
Apr. 3, 2012 (JP) 2012-084533

(51) Int. Cl. A23L 1/09; A23K 1/16; A23L 1/314

(52) U.S. Cl. CPC A23L 1/095; A23L 1/31436; A23K 1/1643; A23V 2002/00
USPC 426/641; 426/661; 426/516

(57) ABSTRACT

A granular material including equal to or larger than 45% by weight of a starch, the starch including a starch composed of one, two or more types of partially degraded starch(es) produced by treating a starch containing amylose at a content of equal to or larger than 5% by weight with any one, two or more of an acid treatment, an oxidation treatment and an enzymatic treatment, at equal to or larger than 7% by weight in the granular material, wherein a water absorption rate, in which the granular material absorbs water for 1 hour at 30 degrees C. by adding 40 g of water to 5 g of the granular material, is equal to or larger than 250% by weight and equal to or smaller than 700% by weight, wherein a compressive syneresis rate, in which a water-absorbed dough that absorbs water for 1 hour at 30 degrees C. by adding 40 g of water to 5 g of the granular material is compressed at a pressure of 141.5 g/cm² at 30 degrees C. for 10 minutes, is equal to or higher than 7% by weight, and wherein a content of particles over a sieve of 0.5 mm aperture in the granular material is equal to or larger than 40% by weight and equal to or smaller than 100% by weight.

### TECHNICAL FIELD

The present invention relates to a granular material and a method for producing thereof, and a food, a forage and an edible meat product employing thereof.

### BACKGROUND ART

Conventionally, bread crumbs, granular vegetal proteins and the like have been utilized as drip-proof agents for preventing drip of bouillon or drip of lipid in hamburg steaks, shao-mai (shumai) or the like.

While the bread crumbs having a higher water absorption ability are effective for preventing the drip, excessive amount of the addition thereof creates a moist and homogeneous eating-texture of the meat processed product, which decreases a ground meat-texture and a fibrous texture of the meat. On the other hand, granular proteins, which are produced by processing soy beans or wheat protein, do not deteriorate the ground meat-texture and the fibrous texture that are originated from the meat, and nevertheless, the use of the granular proteins may be avoided because of problems of allergens derived from the materials, as well as their specific flavors, a burnt shrink caused during the heating process, or the like. Water absorbents for the meat processed products, which can provide solutions for these problems and exhibit an improved eating-texture with reduced their own flavor, are demanded.

Also, in addition to the materials employing the granular bread crumb or the vegetal protein, materials employing starches are those described in Patent Documents 1 to 4.

Patent Document 1 (Japanese Laid-Open Patent Publication No. H08-9907 [1996]) describes a material for a food, which is obtained by gelatinizing a high amylose corn starch with an extruder. This also describes that the obtained material for the food was used in the production of hamburg steaks and fried chickens.

Patent Document 2 (Japanese Laid-Open Patent Publication No. 2006-265490) describes an unprocessed gelatinized starch, which is obtained by gelatinizing an unprocessed starch such as high amylose corn starch or the like through a heat treatment with a drum dryer or the like. It is also described that the unprocessed starch is gelatinized to achieve the fibrous texture or the pulp-like texture.

Patent Document 3 (Japanese Laid-Open Patent Publication No. H05-292934 [1993]) describes a dried extruded food, which is obtained by conducting an extrusion for a solubilized high amylose starch. This Document also describes that a jet heating process and a spray drying process are employed in a treatment for gelatinizing the starch conducted prior to the extrusion processing.

Patent Document 4 (Japanese Laid-Open Patent Publication No. H03-292866 [1991]) describes a material for a dried mashed potato, which is composed of a pulverized product of a gelatinized general corn and a pulverized product of a gelatinized high amylose corn or a gelatinized product of a high amylose corn starch.

### RELATED DOCUMENTS

### Patent Documents

### [Patent Document 1]

Japanese Laid-Open Patent Publication No. H08-9907 (1996)

### [Patent Document 2]

Japanese Laid-Open Patent Publication No. 2006-265490

### [Patent Document 3]

Japanese Laid-Open Patent Publication No. H05-292934 (1993)

### [Patent Document 4]

Japanese Laid-Open Patent Publication No. H03-292866 (1991)

### DISCLOSURE OF THE INVENTION

### Technical Problem

While the material for the food described in Patent Document 1 as described above has a higher water absorption rate, this provides noticeable dry texture unique to the high amylose corn starch with poor meltability, and this also provides strange sensation related to the eating-texture.

On the other hand, the technology described in Patent Document 2 is a technology for merely providing the fibrous texture or the pulp-like texture to the food, and thus is not related to provide an enhanced water absorption rate.

Further, the technology described in Patent Document 3 is a technology for providing the food material having poor water absorbability by conducting the extruder processing for the high amylose corn starch, which is solubilized by the jet heating and the spraying drying, and for the gelatinized starch containing 65% or higher of amylose, branch of which is enzymatically cut off, and therefore such technology has a poor water absorption rate and is not related to prevent the drip.

As described above, there are still scopes for improvements in any of the technologies described in Patent Documents 1 to 4, in terms of providing less unfavorable impact to the eating-texture and the flavor and preventing the drip during the heating or during the microwave heating of the meat processed products such as hamburg steaks or shao-mais.

While the above descriptions have been made in reference to the meat processed products, it is also expected to develop a material, which has a moderately increased water absorption rate when it is blended in the food or the forage and also exhibits suppressed drip and reduced pasty texture unique to the starch.

### Means for Solving the Problem

According to one aspect of the present invention, there is provided a granular material including equal to or larger than 45% by weight of a starch, the aforementioned starch including a starch composed of one, two or more types of partially degraded starch(es) produced by treating a starch containing amylose at a content of equal to or larger than 5% by weight with any one, two or more of an acid treatment, an oxidation treatment and an enzymatic treatment, at equal to or larger than 7% by weight in the granular material, wherein a water absorption rate, in which the granular material absorbs water for 1 hour at 30 degrees C. by adding 40 g of water to 5 g of the granular material, is equal to or larger than 250% by weight and equal to or smaller than 700% by weight, wherein a compressive syneresis rate, in which a water-absorbed dough that absorbs water for 1 hour at 30 degrees C. by adding 40 g of water to 5 g of the granular material is compressed at a pressure of 141.5 g/cm² at 30 degrees C. for 10 minutes, is equal to or higher than 7% by weight, and wherein a content of particles over a sieve of 0.5 mm aperture in the granular material is equal to or larger than 40% by weight and equal to or smaller than 100% by weight.

According to another aspect of the present invention, there is provided a method for producing the above-described granular material of the present invention, including: a step for granulating a raw material including the aforementioned starch composed of one, two or more of the aforementioned partially degraded starch by heating and compressing with an extruder.

According to further aspect of the present invention, there is provided a food, a forage or an edible meat product, including the above-described granular material of the present invention.

In addition to above, any arbitrary combination of each of these constitutions or conversions between the categories of the invention such as a process, a device, a method for utilizing the device and the like may also be within the scope of the present invention.

For example, according to yet other aspect of the present invention, there is provided a method for producing a food or a forage including a step for blending the above-described granular material of the present invention.

Alternatively, according to yet other aspect of the present invention, there is provided an edible meat improver agent including the above-described granular material of the present invention.

### Advantageous Effects of Invention

According to the present invention, a novel material, which has a moderately increased water absorption rate and also exhibits suppressed drip and suppressed pasty texture unique to the starch, can be obtained.

### DESCRIPTION OF EMBODIMENTS

In a granular material according to the present embodiment, a content of particles over a sieve of 0.5 mm aperture is equal to or higher than 40% by weight and equal to or lower than 100% by weight, and any shape thereof is acceptable.

In view of reducing a stickiness when added in the food or the like, the content of the particles over the sieve of 0.5 mm aperture according to JIS-Z8801-1 standard is equal to or higher than 40% by weight, and is preferably equal to or higher than 50% by weight, and is further preferably equal to or higher than 70% by weight. On the other hand, the upper limit of the content of the particles over the sieve of 0.5 mm aperture is not limited and is equal to or lower than 100% by weight, and for the purpose of further improvement of the eating-texture and the like, it may be for example, equal to or lower than 99.5% by weight, equal to or lower than 95% by weight, or equal to or less than 85% by weight and the like.

Also, the upper limit of the particle size of the granular material may be suitably adjusted in consideration of the dimension or the like of the edible meat-processed product or the like containing the granular material blended therein, and for example, the content of the particles over a sieve of 9.16 mm aperture according to JIS-Z8801-1 standard may be equal to or lower than 50% by weight, and may be preferably equal to or lower than 30% by weight, and may be further preferably equal to or lower than 10% by weight.

The granular material according to the present embodiment contains the starch as an essential constituent.

More specifically, in view of suppressing a dry texture or a deterioration in the flavor when blended in the food, the granular material of the present embodiment contains the starch at equal to or larger than 45% by weight, and it is preferable to be mainly composed of the starch or in other words the starch content is preferably equal to or higher than 50% by weight, and is further preferably equal to or higher than 65% by weight.

On the other hand, the upper limit of the starch content in the granular material is not limited and is equal to or smaller than 100% by weight, and according to the eating-texture and the like of the food product containing thereof, it may be for example, equal to or smaller than 99.5% by weight, equal to or lower than 95% by weight, or equal to or smaller than 85% by weight and the like.

Also, the granular material according to the present embodiment contains, as the above-described starch, a starch degraded by treating a starch containing amylose at a content of equal to or larger than 5% by weight with any one, two or more of an acid treatment, an oxidation treatment and an enzymatic treatment (hereinafter, referred to as “partially degraded starch”) as an essential constituent. The partially degraded starch is a mixture of one, two or more thereof.

The term “degradation” employed here means a degradation accompanied with a reduction of a molecular weight, and typical degradation techniques include a degradation by treatment(s) of any one, two or more of an acid treatment, an oxidation treatment and an enzymatic treatment. Among these, in view of the degradation rate, the production cost and the reproducibility of the degradation reaction, the acid treatment may be the best choice.

The content of the above-described partially degraded starch in the granular material is equal to or larger than 7% by weight, in view of suppressing the pasty texture when blended in the food to provide a natural eating-texture, and is preferably equal to or larger than 12% by weight, and is further preferably equal to or larger than 17% by weight.

On the other hand, the upper limit of the content of the above-described partially degraded starch in the granular material is not limited and is equal to or smaller than 100% by weight, and is suitably established depending on the amylose content in the raw starch for the partially degraded starch. The amylose content in the raw starch for the partially degraded starch is equal to or larger than 5% by weight, and is preferably equal to or larger than 12% by weight, and further preferably equal to or larger than 18% by weight. In addition to above, the upper limit of the amylose content in the raw starch for the partially degraded starch is not limited and is equal to or smaller than 100% by weight.

While the degree of the degradation of the partially degraded starch can be suitably adjusted, the peak molecular weight of the starch after the degradation may be within a range of equal to or higher than 5×10³ and equal to or lower than 8×10⁴, and may be preferably equal to or higher than 6×10³ and equal to or lower than 6×10⁴, and may be further preferably equal to or higher than 6×10³ and equal to or lower than 4×10⁴. Excessively lower degree of the degradation may cause an insufficient suppression of the pasty texture that is unique to the starch itself, causing an unfavorable impact on the eating-texture. Also, excessively higher degree of the degradation may cause an excessively lower water absorption rate and insufficient drip-depression effect. In addition to above, the method for measuring the peak molecular weight of the starch after the degradation will be discussed later in the section of Examples.

Also, in the granular material according to the present embodiment, a product obtainable by multiplying the amylose content (% by weight) of the partially degraded starch in the raw starch with the blending quantity (% by weight) of the above-mentioned partially degraded starch in the granular material may be, for example, equal to or higher than 5×10², in view of suppressing the stickiness when blended in the food and suppressing deterioration of the original eating-quality or eating-texture of the food, and may be preferably equal to or higher than 1×10³, and may be further preferably equal to or higher than 1.2×10³. On the other hand, the above-described product may be, for example, equal to or lower than 3×10³, and may be preferably equal to or lower than 2.5×10³.

Also, the granular material according to the present embodiment is configured to satisfy the specific conditions for the water absorption rate and the compressive syneresis rate, respectively.

More specifically, the water absorption rate, in which the granular material absorbs water for 1 hour at 30 degrees C. by adding 40 g of water to 5 g of the granular material, may be equal to or higher than 250% by weight, and may be preferably equal to or higher than 350% by weight, and may be further preferably equal to or higher than 400% by weight. An excessively lower water absorption rate may cause an insufficient drip-depression effect.

On the other hand, an excessively higher water absorption rate may cause a mushy eating-texture, and thus the water absorption rate, in which the granular material absorbs water for 1 hour at 30 degrees C. by adding 40 g of water to 5 g of the granular material, may be equal to or lower than 700% by weight, and may be preferably equal to or lower than 660% by weight, and may be further preferably equal to or lower than 600% by weight.

Also, in order to provide preferable eating-texture of the food containing the granular material blended therein, the compressive syneresis rate, in which the water-absorbed dough absorbs water for 1 hour at 30 degrees C. by adding an excessive quantity of water or more specifically 40 g of water to 5 g of the granular material, may be equal to or higher than 7% by weight, and may be preferably equal to or higher than 10% by weight, and may be further preferably equal to or higher than 15% by weight. An excessively lower compressive syneresis rate may cause increased stickiness in the eating-texture in, for example, the heating cooking, failing to achieve the preferable eating-texture.

The upper limit of the compressive syneresis rate of the granular material may be for example equal to or lower than 70% by weight, in view of suppressing the dry texture of the granular material in the heating cooking, and may be preferably equal to or lower than 50% by weight, and may be further preferably equal to or lower than 30% by weight.

Also, in the granular material of the present embodiment, the degree of gelatinization of the starch in the granular material determined by a β-amylase pullulanase (BAP) method may be, for example, equal to or higher than 20% in view of moderately enhancing the water absorption rate, and may be preferably equal to or higher than 40%. The upper limit of the degree of gelatinization of the granular material is not limited and thus may be equal to or lower than 100%, and may preferably be equal to or lower than 80%, in view of suppressing the stickiness when blended in the food, and may be further preferably equal to or lower than 60%.

In the present embodiment, various types of starches may be employed as the component of the starch in the granular material except the above-described partially degraded starch. More specifically, any of starches that are available in the market depending upon applications such as a starch for a food or a forage, may be employed regardless of the types of the starches, and typically one or more of: starches such as corn starch, potato starch, tapioca starch, wheat starch and the like; and modified starches produced by physically, chemically or biologically processing these starches may be suitably selected. It may be preferable to contain one, two or more types of starch(es) selected from the group consisting of corn starch, wheat starch, potato starch, tapioca starch and cross-linked starch.

A component except the starch may also be blended in the granular material according to the present embodiment.

Specific examples of such component except the starch may include pigments such as cacao pigment and the like; emulsifying agents; and insoluble salts such as calcium carbonate and the like.

For example, the granular material may be suitably colored by adding a pigment such that the appearance of the granular material is similar to the color of the meat, and therefore this allows reducing a strange sensation on an appearance by merging the appearances of the granular material and the edible meat product together.

Since the hardness of the granular material can be suitably adjusted by suitably blending the emulsifying agent, the eating-texture can be changed according to the type of the food to be blended.

Also, an insoluble salt such as calcium carbonate and the like may be added to stabilize a cellular (an air bubble) structure of the granular material, providing improved production stability.

Next, a method for producing the granular material according to the present embodiment will be described. The method for producing the granular material according to the present invention includes, for example, a step for granulating a raw material containing a starch that is acid treated, oxidation treated or enzyme treated, by heating and compressing with an extruder.

Also, the granular material according to the present embodiment may be produced by, more specifically, granulating the raw material containing the starch so as to provide the granular material having the size, in which the content of the particles over the sieve of 0.5 mm aperture is equal to or higher than 40% by weight and equal to or lower than 100% by weight, and may also be preferable to be thermally gelatinized during the granulation. As general methods employed for the thermal gelatinization of the starch, thermal gelatinization processes employing machines such as a drum dryer, a jet cooker, an extruder and the like are known, and in view of obtaining the granular material that satisfies the specific conditions for the water absorption rate and the compressive syneresis rate with higher efficiency, the thermal gelatinizations with extruders are the most suitable in the present embodiment. Among these, in view of more firmly obtaining the granular material that satisfies the specific conditions for the water absorption rate and the compressive syneresis rate, a process employing an extruding granulator such as a twin-screw extruder and the like may be preferable. This process allows gelatinizing at least the vicinity of the surface of the granular material and obtaining the granular material with moderately low density, such that the granular material with a moderately increased water absorption rate and enhanced depression effect for the syneresis can be further stably obtained. When the processing with the extruder is to be conducted, water is ordinarily added to the raw material containing the starch to adjust the water content within a range of about 8 to 50% by weight, and then a thermal swelling process is carried out under, for example, conditions that a barrel temperature is from 30 to 200 degrees C., an outlet temperature is from 80 to 200 degrees C., and a screw speed is from 100 to 1,000 rpm and the thermal processing duration time is from 5 to 60 seconds.

Also, when the raw materials for the use in the granulation are prepared, the partially degraded starch may be blended to other raw materials, so that a product obtainable by multiplying the amylose content (% by weight) of the above-described partially degraded starch in the raw starch with the blending quantity (% by weight) of the partially degraded starch in the granular material falls within the above-described specific range. Then, it may be preferable that the granular material obtained by the thermal gelatinization is pulverized and sieved as required to suitably adjust the particle sizes. This can more stably provide the water absorption rate to be fallen within the above-described specific range.

Since the granular material obtainable in the present embodiment contains the above-described partially degraded starch and is configured to satisfy the specific conditions for any of the size of the granular material, the content of the starch, the content of the partially degraded starch, the water absorption rate and the compressive syneresis rate, so that the water absorption rate is moderately increased, the effect for depressing the drip is enhanced, and the compressive syneresis rate is moderately increased, and the pasty texture unique to the starch is effectively suppressed, and therefore for example, this may be effectively employed as the water-absorbing material blended in the food or in the forage. Also, the granular material obtainable in the present embodiment can be added to the edible meat product to provide the preferable eating-texture to the edible meat product, and thus can be preferably employed as an edible meat processing agent.

Also, the food and the forage according to the present embodiment contain the obtained granular material.

Specific examples of the food may include: livestock meat processed foods such as hamburg steaks, meat balls, shao-mai (shumai), dumplings, sausage and the like; fish meat processed foods such as fish meat sausages, minced fish and the like; salads such as potato salads, bean-curd residues and the like; and serial foods. Also, these also typically include delicatessen foods including marinated foods, simmered foods, stuffed breads and the like, in addition to the livestock meat processed foods, fish meat processed foods and salads.

Also, specific examples of the forages include pet foods for dogs or cats, or compound feeds for livestock or fowls.

### EXAMPLES

Examples of the present invention will be described as follows, and it is not intended to limit the scope and the spirit of the present invention thereto.

In the following examples, the unit for the formulation is “% by weight,” unless otherwise indicated. The “part” is “part by weight” unless otherwise indicated.

The following materials were employed for the raw materials: high amylose corn starch (commercially available from J-OIL MILLS, Inc., amylose content 70%);

corn starch (commercially available from J-OIL MILLS, Inc., amylose content 25%);
waxy corn starch (commercially available from J-OIL MILLS, Inc., amylose content 0%);
tapioca starch (commercially available from J-OIL MILLS, Inc., amylose content 16%);
cross-linked tapioca starch (commercially available from J-OIL MILLS, Inc.);
wheat starch (commercially available from J-OIL MILLS, Inc.);
potato starch (commercially available from J-OIL MILLS, Inc.);
calcium carbonate (commercially available from SHIRAISHI CALCIUM KAISHA, LTD, Collocalso Ex);
defatted soybean powder (commercially available from Nikka Oil Mills Co., Ltd., Milky S); and
emulsifying agent (commercially available from Riken Vitamin Co., Ltd., Emulsy MS).

Manufactures of partially degraded starches via an acid treatment, an oxidation treatment and an enzymatic treatment were carried out by the following processes.

### (Acid Treatment)

A starch was suspended in water to prepare a 32% (w/w) slurry. A hydrochloric acid aqueous solution, which had been prepared to be 7.0 N, was added thereto at a ratio of 1/14 times of the slurry weight while being stirred, and the temperature of the slurry was adjusted to 50 degrees C. Assuming that the start of the reaction was at the point in time to reach to 50 degrees C., and after 16 hours of the reaction from that point, the slurry was neutralized with 3% NaOH, and then was washed with water, was dehydrated and was dried to obtain an acid-treated starch. The acid treatments were carried out for the various types of starches of the high amylose corn starch, the corn starch, the waxy corn starch and the tapioca starch. The peak molecular weights of the obtained acid-treated high amylose corn starch, the acid-treated corn starch, the acid-treated waxy corn starch and the acid-treated tapioca starch were 1.2×10⁴ (12204), 1.9×10⁴, 2.3×10⁴, and 2.1×10⁴, respectively.

Also, in Example as will be discussed later (Table 8), acid-treated high amylose corn starches having different degrees of degradation, which were prepared by employing different time durations for the reaction of the acid treatment ranging from 2 hours to 30 hours, were used.

### (Oxidation Treatment)

199 g of water was added to 150 g of a high amylose corn starch to obtain a suspension slurry. 79 g of sodium hypochlorite of available chlorine 13% was added thereto while being stirred, and a reaction was caused at pH 8 and 40 degrees C. while being stirred for 4 hours. After the reaction, it was neutralized with 3% hydrochloric acid solution, and then was washed with water, was dehydrated and was dried to obtain an oxidized high amylose corn starch.

### (Enzymatic Treatment)

300 g of a high amylose corn starch was mixed with 400 g of water, and 2,600 g of boiling water was further added and was stirred well, and then, was auto clave-cured at 121 degrees C. for 7 hours (with auto clave machine for retortable pouch, SR-240, commercially available from TOMY SEIKO CO., LTD.). This was allowed to stand at 24 degrees C. for 24 hours, and then at 48 degrees C. for 48 hours, and then water was added to adjust the concentration of the slurry (w/w) to 10%. Further, 300 mL of solution of Bacillus subtilis-derived α amylase (commercially available from Wako Pure Chemical Industries), which had been prepared to be 450 IU/mL, was added thereto to carry out an enzymatic treatment at 24 degrees C. for 24 hours. After the reaction, it was washed with water, and was washed with 70% ethanol, was dehydrated and was dried to obtain an enzymatically-treated high amylose corn starch.

Further, in the following examples, the water absorption rate, the compressive syneresis rate, the peak molecular weight and the degree of gelatinization and the like were measured with the following methods.

### (Method for Measuring Water Absorption Rate)

(1) 5 g of a sample was weighed in a Falcon® tube of 50 mL volume.
(2) Distilled water of a weight of 8 times thereof was added to sample of the above item (1), and the sample was dipped at 30 degrees C. for 1 hour.
(3) The dipped dough was placed on a sieve of 0.5 mm aperture, and then water was well removed. More specifically, the sieve was allowed to stand for 3 minutes with an inclination at 30 degrees.
(4) Water absorption rate of the dough after the removal of water was determined on the basis of the following formula.

Water absorption rate (% by weight)=(dough weight after water absorption−dough weight before water absorption)/dough weight before water absorption×100.

### (Method for Measuring Compressive Syneresis Rate)

(1) 50 mL syringe (“Terumo syringe” SS-50ES commercially available from Terumo) was prepared. The leading end thereof was stuffed with Kim Wipe, and then a tape was wound to block the leading end.
(2) According to the procedures (1) to (3) in the above-described “Method for measuring water absorption rate”, an inside of a syringe without a piston was packed with the whole quantity of the water-absorbed dough.
(3) A rubber attached on the leading end of the piston was removed off, and was set to the syringe. At this time, the syringe was stood vertically.
(4) A weight (1 kg) was placed on the top of the piston to compress the dough, and was allowed to stand still for 5 minutes. This achieved the conditions, in which a dough-compressing area of the syringe was 7.065 cm² (radius 1.5 cm) and a load per unit area was 141.5 g/cm².
(5) The compressive syneresis was removed, and then the weight of the dough was determined on the basis of the following formula. In addition to above, when a syneresis liquid was not able to be isolated from the compressive dough, the result of such case was indicated as immeasurable (N.D).

Compressive syneresis rate (% by weight)=(1−dough weight after syneresis (g)/dough weight (g) filled in the syringe)×100.

### (Method for Measuring Peak Molecular Weight)

The measurement of the peak molecular weight was carried out by employing an HPLC unit commercially available from TOSOH CORPORATION (pump: DP-8020, RI detector: RS-8021, and degasifier: SD-8022).

(1) A sample was pulverized to adjust the size as being equal to or smaller than the aperture of 0.15 mm according to JIS-Z8801-1 standard. This sample was suspended in a moving phase so as to achieve 1 mg/mL, and the resultant suspension was heated at 100 degrees C. for 3 minutes to be completely dissolved. A filtration was conducted by using a 0.45 μm filtration filter (commercially available from ADVANTEC Co., Ltd., DISMIC-25HP PTFE 0.45 μm), and the resultant filtrate was obtained as an analytical sample.
(2) Molecular weight was measured under the following analytical conditions.
column: TSK gel α-M (7.8 mm φ, 30 cm) (commercially available from TOSOH CORPORATION), two columns;
flow rate: 0.5 mL/min.;
moving phase: 5 mM NaNO₃-containing 90% (v/v) dimethylsulfoxide solution;
column temperature: 40 degrees C.; and
analytical quantity: 0.2 mL.
(3) Detector data were collected by utilizing a software (Multistation GPC-8020, Model II, Data acquisition ver5.70), commercially available from TOSOH CORPORATION, and a molecular weight peak was calculated.

A pullulan (commercially available from Showa Denko Co., Ltd., Shodex Standard P-82), molecular weight of which had been known, was employed for a calibration curve.

### (Method for Measuring Degree of Gelatinization)

A measurement of the degree of gelatinization for the starch in the granular material was conducted by a β-amylase-pullulanase (BAP) process.

(1) The granular material was pulverized in advance to adjust the particle size as being equal to or smaller than the aperture of 0.15 mm, which was employed as a measurement sample.
(2) According to the process described in Journal of the Japanese Society of Starch Science, Vol. 28, 4, pp. 235-240 (1981), entitled “New measuring method for gelatinizing degree and aging degree of starch by employing β-amylase-pullulanase (BAP) system”, the degree of gelatinization of the starch in the granular material was measured.

In the following examples, a method for sensory evaluation and criteria for evaluation were as follows.

### (Method for Sensory Evaluation)

(1) A sample 20 g was weighed in a beaker of 500 mL capacity.
(2) Distilled water of a weight of 4 times thereof was added to the sample of the above-described (1), and was dipped at a room temperature (about 30 degrees C.) for 1 hour, and then the dipped dough was placed on a sieve of 0.5 mm aperture and water was well removed.
(3) 25 parts of the sample prepared according to the above-described (2) was added to a dough prepared by kneading raw materials, which contained 40.0 parts of commercially available chicken minced meat, 17.0 parts of onion, 14.0 parts of bread crumbs, 12.0 parts of edible oil, 8.0 parts of corn starch, 6.8 parts of water, 1.0 part of sugar, 0.7 part of common salt, 0.3 part of sodium glutamate, and 0.2 part of pepper, and the dough was kneaded well once again.
(4) Each of 50 g of a flat dough was prepared by die-punching the dough containing the sample impregnated therein, and was steamed by employing a steam oven at 250 degrees C. for 5 minutes, and then was radiationally-cooled at a room temperature for 1 hour, and eventually the resultant product was employed as a sample for a sensory evaluation.

### (Sensory Evaluation Criteria)

The sensory evaluations were conducted with 10 special panelists for the obtained sample for the sensory evaluation on “stickiness reduction effect”, “absence of dry texture”, “flavor” and “overall evaluation for sensory”. The evaluation was conducted with four criteria, and an average of the sensory evaluation results for all the panelists was obtained. For the respective results of the evaluations, the average of equal to or larger than 3.5 points was assigned as “⊚” (double circle), the average of equal to or larger than 2.5 points and lower than 3.5 points was assigned as “◯” (circle), the average of equal to or larger than 1.5 points and lower than 2.5 points was assigned as “Δ,” (triangle), and the average of lower than 1.5 was assigned as “x” (cross). Criteria for the evaluations are shown as follows. Stickiness reduction effect:

1: sticky;
2: slightly sticky;
3: not so sticky; and
4: not sticky.

### Absence of Dry Texture:

1: dry texture;
2: slightly dry texture;
3: not so dry texture; and
4: not dry texture.

### Flavor

1: there is a bad smell (a smell blocking original meat flavor);
2: bad smell is slightly felt;
3: there is not much bad smell; and
4: there is no smell.

### Overall Evaluation for Sensory

1: not good;
2: not so good;
3: slightly good; and
4: good.

### Examples 1 to 10 and Comparative Examples 1 to 4

Raw materials were blended according to the formulation as shown in Table 1, and the materials were mixed in a bag until it was sufficiently uniformly mixed. An obtained mixture was compressively and thermally processed by employing a twin-screw extruder (KEI-45, commercially available from KOWA INDUSTRIES CO., LTD.). The processing conditions were as follows.

Raw material supply: 340 g/minute,
hydration: 12%,
Barrel temperature: 60 degrees C., 100 degrees C. and 130 degrees C. from a raw material inlet toward an outlet,
outlet temperature: 120 to 130 degrees C., and
rotating speed of screw: 250 rpm.

Granulated substances obtained by the extruder processing were dried at 110 degrees C. to adjust the water content as 8 to 12%.

Subsequently, the dried granulated substance was pulverized with a mill (mill commercially available from KOKKO, HIKARI A1-V). (While the particle size distribution in such case depends upon the type of the granulated substance, particles undersize of the 9.16 mm aperture and oversize of 5.6 mm aperture was 10 to 20% by weight; particles undersize of the 5.6 mm aperture and oversize of 2.36 mm aperture was 30 to 50% by weight; 30-50% by weight, particles undersize of the 2.36 mm aperture and oversize of 0.5 mm aperture was 10 to 30% by weight; and particles undersize of the 0.5 mm aperture was 10 to 40% by weight, according to JIS-Z8801-1 standard.)

This pulverized product was sieved with a sieve of 0.5 mm aperture, and the fraction of the oversize particles were employed as a sample. The measurement results of the water absorption rate and the compressive syneresis rate and the results of the sensory evaluations of the granular material obtained by the above-described treatments are shown in Table 2.

TABLE 1

| | | FORMULA- | FORMULA- | FORMULA- | FORMULA- | FORMULA- | FORMULA- | FORMULA- |
|---|---|---|---|---|---|---|---|---|
| | | TION 1 | TION 2 | TION 3 | TION 4 | TION 5 | TION 6 | TION 7 |
| COMPONENT | ACID-TREATED HIGH | | 5 | 10 | 15 | 20 | 30 | 40 |
| (% BY WEIGHT) | AMYLOSE CORN STARCH | | | | | | | |
| | ACID-TREATED CORN | | | | | | | |
| | STARCH | | | | | | | |
| | ACID-TREATED TAPIOCA | | | | | | | |
| | STARCH | | | | | | | |
| | ACID-TREATED WAXY | | | | | | | |
| | CORN STARCH | | | | | | | |
| | CORN STARCH | 99 | 94 | 89 | 84 | 79 | 69 | 59 |
| | CALCIUM CARBONATE | 1 | 1 | 1 | 1 | 1 | 1 | 1 |
| AMYLOSE CONTENT (% BY WEIGHT) | | — | 70% | | | | | |
| OF PARTIALLY DEGRADED | | | | | | | | |
| STARCH IN RAW STARCH (A) | | | | | | | | |
| BLENDING QUANTITY (% BY WEIGHT) | | 0% | 5% | 10% | 15% | 20% | 30% | 40% |
| OF PARTIALLY DEGRADED | | | | | | | | |
| STARCH IN GRANULAR MATERIAL (B) | | | | | | | | |
| (A) × (B) | | 0 | 350 | 700 | 1050 | 1400 | 2100 | 2800 |
| | | FORMULA- | FORMULA- | FORMULA- | FORMULA- | FORMULA- | FORMULA- | FORMULA- |
| | | TION 8 | TION 9 | TION 10 | TION 11 | TION 12 | TION 13 | TION 14 |
| COMPONENT | ACID-TREATED HIGH | | | | | | | |
| (% BY WEIGHT) | AMYLOSE CORN STARCH | | | | | | | |
| | ACID-TREATED CORN | 20 | 30 | 50 | 99 | | | |
| | STARCH | | | | | | | |
| | ACID-TREATED TAPIOCA | | | | | 50 | | |
| | STARCH | | | | | | | |
| | ACID-TREATED WAXY | | | | | | 20 | 50 |
| | CORN STARCH | | | | | | | |
| | CORN STARCH | 79 | 69 | 49 | 0 | 49 | 79 | 49 |
| | CALCIUM CARBONATE | 1 | 1 | 1 | 1 | 1 | 1 | 1 |

| AMYLOSE CONTENT (% BY WEIGHT) | 25% | | | | 16% | 0% | |
|---|---|---|---|---|---|---|---|
| OF PARTIALLY DEGRADED | | | | | | | |
| STARCH IN RAW STARCH (A) | | | | | | | |
| BLENDING QUANTITY (% BY WEIGHT) | 20% | 30% | 50% | 100% | 50% | 20% | 50% |
| OF PARTIALLY DEGRADED | | | | | | | |
| STARCH IN GRANULAR MATERIAL (B) | | | | | | | |
| (A) × (B) | 500 | 750 | 1250 | 2500 | 800 | 0 | 0 |

TABLE 2

| | COM- | COM- | | | | | |
|---|---|---|---|---|---|---|---|
| | PARATIVE | PARATIVE | | | | | |
| | EXAM- | EXAM- | EXAM- | EXAM- | EXAM- | EXAM- | EXAM- |
| | PLE 1 | PLE 2 | PLE 1 | PLE 2 | PLE 3 | PLE 4 | PLE 5 |
| FORMULATION | FORMULA- | FORMULA- | FORMULA- | FORMULA- | FORMULA- | FORMULA- | FORMULA- |
| | TION 1 | TION 2 | TION 3 | TION 4 | TION 5 | TION 6 | TION 7 |
| PARTICLE SIZE (APERTURE OF EQUAL | 100% | 100% | 100% | 100% | 100% | 100% | 100% |
| TO OR LARGER THAN 0.5 mm) | | | | | | | |
| (% BY WEIGHT) | | | | | | | |
| WATER ABSORPTION RATE (%) | N.D. | N.D. | 457% | 478% | 488% | 493% | 473% |
| | (>800%) | (>800%) | | | | | |
| COMPRESSIVE SYNERESIS RATE (%) | N.D. | N.D. | 8% | 19% | 21% | 24% | 33% |
| STICKINESS REDUCTION EFFECT | X | X | Δ | ◯ | ⊚ | ⊚ | ⊚ |
| ABSENCE OF DRY TEXTURE | ⊚ | ⊚ | ⊚ | ⊚ | ⊚ | ◯ | Δ |
| FLAVOR | ⊚ | ⊚ | ⊚ | ⊚ | ⊚ | ⊚ | ⊚ |
| OVERALL EVALUATION FOR SENSORY | X | X | Δ | ◯ | ⊚ | ⊚ | Δ |
| | | | | | | COM- | COM- |
| | | | | | | PARATIVE | PARATIVE |
| | EXAM- | EXAM- | EXAM- | EXAM- | EXAM- | EXAM- | EXAM- |
| | PLE 6 | PLE 7 | PLE 8 | PLE 9 | PLE 10 | PLE 3 | PLE 4 |
| FORMULATION | FORMULA- | FORMULA- | FORMULA- | FORMULA- | FORMULA- | FORMULA- | FORMULA- |
| | TION 8 | TION 9 | TION 10 | TION 11 | TION 12 | TION 13 | TION 14 |
| PARTICLE SIZE (APERTURE OF EQUAL | 100% | 100% | 100% | 100% | 100% | 100% | 100% |
| TO OR LARGER THAN 0.5 mm) | | | | | | | |
| (% BY WEIGHT) | | | | | | | |
| WATER ABSORPTION RATE (%) | 559% | 498% | 453% | 442% | 484% | N.D. (>800%) | 366% |
| COMPRESSIVE SYNERESIS RATE (%) | 10% | 16% | 21% | 23% | 17% | N.D. | 5% |
| STICKINESS REDUCTION EFFECT | Δ | Δ | ◯ | ⊚ | Δ | X | X |
| ABSENCE OF DRY TEXTURE | ⊚ | ⊚ | ⊚ | ⊚ | ⊚ | ⊚ | ⊚ |
| FLAVOR | ⊚ | ⊚ | ⊚ | ⊚ | ⊚ | ⊚ | ⊚ |
| OVERALL EVALUATION FOR SENSORY | Δ | Δ | ◯ | ⊚ | Δ | X | X |

In Table 2, the degree of the gelatinization of the starch in the granular material in Example 3 was 55%.

### Examples 11 to 13 and Comparative Examples 5 and 6

Raw materials were blended according to the formulation 5 as shown in Table 1, and granular materials were produced and then were pulverized according to the method described in Example 1. In the subsequent screening step, the granular material was classified into oversize particles for the 0.5 mm aperture and undersize particles for the 0.5 mm aperture, and the two fractions were mixed according to the formulations shown in Table 3 to obtain the granular materials having different particle sizes. The results of the evaluations of the granular materials having different particle sizes thus obtained are shown in Table 3.

TABLE 3

| | COM- | | | | | |
|---|---|---|---|---|---|---|
| | PARATIVE | COMPARATIVE | | | | |
| | EXAMPLE 5 | EXAMPLE 6 | EXAMPLE 11 | EXAMPLE 12 | EXAMPLE 13 | EXAMPLE 3 |
| FORMULATION | FORMULA- | FORMULA- | FORMULA- | FORMULA- | FORMULA- | FORMULA- |
| | TION 5 | TION 5 | TION 5 | TION 5 | TION 5 | TION 5 |
| PARTICLE SIZE (APERTURE OF EQUAL | 0% | 20% | 40% | 60% | 80% | 100% |
| TO OR LARGER THAN 0.5 mm) | | | | | | |
| (% BY WEIGHT) | | | | | | |
| WATER ABSORPTION RATE (%) | 588% | 562% | 541% | 522% | 491% | 488% |
| COMPRESSIVE SYNERESIS RATE (%) | N.D. | 2% | 7% | 13% | 18% | 21% |
| STICKINESS REDUCTION EFFECT | X | X | Δ | ◯ | ⊚ | ⊚ |
| ABSENCE OF DRY TEXTURE | ⊚ | ⊚ | ⊚ | ⊚ | ⊚ | ⊚ |
| FLAVOR | ⊚ | ⊚ | ⊚ | ⊚ | ⊚ | ⊚ |
| OVERALL EVALUATION FOR SENSORY | X | X | Δ | ◯ | ⊚ | ⊚ |

### Examples 14 to 18 and Comparative Examples 7 to 9

Raw materials were blended according to the formulation as shown in Table 4, and granular materials were produced according to the method described in Example 1. The results of the evaluations for the obtained granular materials are shown in Table 5.

TABLE 4

| | | FOR- | FOR- | FOR- | FOR- | FOR- | | | |
|---|---|---|---|---|---|---|---|---|---|
| | | MULA- | MULA- | MULA- | MULA- | MULA- | FORMULA- | FORMULA- | FORMULA- |
| | | TION 15 | TION 16- | TION 17- | TION 18- | TION 19- | TION 20- | TION 21- | TION 22- |
| COMPONENT | ACID-TREATED HIGH | 18 | 16 | 14 | 12 | 10 | 8 | 4 | 0 |
| (% BY WEIGHT) | AMYLOSE CORN | | | | | | | | |
| | STARCH | | | | | | | | |
| | CORN STARCH | 71.1 | 63.2 | 55.3 | 47.4 | 39.5 | 31.6 | 15.8 | 0 |
| | CALCIUM CARBONATE | 0.9 | 0.8 | 0.7 | 0.6 | 0.5 | 0.4 | 0.2 | 0 |
| | DEFATTED SOYBEAN | 10 | 20 | 30 | 40 | 50 | 60 | 80 | 100 |
| | POWDER | | | | | | | | |

| AMYLOSE CONTENT (% BY WEIGHT) | 70% | | | | | | | |
|---|---|---|---|---|---|---|---|---|
| OF PARTIALLY DEGRADED | | | | | | | | |
| STARCH IN RAW STARCH (A) | | | | | | | | |
| BLENDING QUANTITY (% BY WEIGHT) | 18% | 16% | 14% | 12% | 10% | 8% | 4% | 0% |
| OF PARTIALLY DEGRADED | | | | | | | | |
| STARCH IN GRANULAR | | | | | | | | |
| MATERIAL (B) | | | | | | | | |
| (A) × (B) | 1260 | 1120 | 980 | 840 | 700 | 560 | 280 | 0 |

TABLE 5

| | | | | | | | COM- | COM- | COM- |
|---|---|---|---|---|---|---|---|---|---|
| | | | | | | | PARATIVE | PARATIVE | PARATIVE |
| | EXAM- | EXAM- | EXAM- | EXAM- | EXAM- | EXAM- | EXAM- | EXAM- | EXAM- |
| | PLE 3 | PLE 14 | PLE 15 | PLE 16 | PLE 17 | PLE 18 | PLE 7 | PLE 8 | PLE 9 |
| FORMULATION | FOR- | FOR- | FOR- | FOR- | FOR- | FOR- | FOR- | FOR- | FOR- |
| | MULA- | MULA- | MULA- | MULA- | MULA- | MULA- | MULA- | MULA- | MULA- |
| | TION 5 | TION 15 | TION 16 | TION 17 | TION 18 | TION 19 | TION 20 | TION 21 | TION 22 |
| PARTICLE SIZE (APERTURE | 100% | 100% | 100% | 100% | 100% | 100% | 100% | 100% | 100% |
| OF EQUAL TO OR LARGER | | | | | | | | | |
| THAN 0.5 mm) (% BY WEIGHT) | | | | | | | | | |
| WATER ABSORPTION RATE (%) | 488% | 478% | 445% | 464% | 421% | 390% | 320% | 298% | 236% |
| COMPRESSIVE | 21% | 19% | 16% | 20% | 15% | 13% | 13% | 14% | 17% |
| SYNERESIS RATE (%) | | | | | | | | | |
| STICKINESS REDUCTION | ⊚ | ⊚ | ⊚ | ⊚ | ⊚ | ⊚ | ⊚ | ⊚ | ⊚ |
| EFFECT | | | | | | | | | |
| ABSENCE OF DRY TEXTURE | ⊚ | ⊚ | ⊚ | ⊚ | ◯ | Δ | Δ | X | X |
| FLAVOR | ⊚ | ◯ | ◯ | Δ | Δ | Δ | X | X | X |
| OVERALL EVALUATION | ⊚ | ◯ | ◯ | Δ | Δ | Δ | X | X | X |
| FOR SENSORY | | | | | | | | | |

### Examples 19 and 20

Raw materials were blended according to the formulation as shown in Table 6, and granular materials were produced according to the method described in Example 1. The results of the evaluations for the obtained granular materials are shown in Table 7.

TABLE 6

| | | FORMULATION | FORMULATION | FORMULATION |
|---|---|---|---|---|
| | | 5 | 23 | 24 |
| COMPONENT | ACID-TREATED HIGH | 20 | | |
| (% BY WEIGHT) | AMYLOSE CORN STARCH (12204) | | | |
| | ENZYME-TREATED HIGH | | 20 | |
| | AMYLOSE CORN STARCH (9012) | | | |
| | OXIDATIVELY-TREATED HIGH | | | 20 |
| | AMYLOSE CORN STARCH (38201) | | | |
| | CORN STARCH | 79 | 79 | 79 |
| | CALCIUM CARBONATE | 1 | 1 | 1 |

| AMYLOSE CONTENT (% BY WEIGHT) OF PARTIALLY | 70% | | |
|---|---|---|---|
| DEGRADED STARCH IN RAW STARCH (A) | | | |
| BLENDING QUANTITY (% BY WEIGHT) OF | 20% | 20% | 20% |
| PARTIALLY DEGRADED STARCH IN GRANULAR | | | |
| MATERIAL (B) | | | |
| (A) × (B) | 1400 | 1400 | 1400 |

 NUMERICAL VALUE IN PARENTHESES REPRESENTS PEAK MOLECULAR WEIGHT

TABLE 7

| | EXAMPLE 3 | EXAMPLE 19 | EXAMPLE 20 |
|---|---|---|---|
| STARCH DEGRADING METHOD | ACID | ENZYME | OXIDATION |
| | TREATMENT | TREATMENT | TREATMENT |
| FORMULATION | FORMULATION 5 | FORMULATION 23 | FORMULATION 24 |
| PARTICLE SIZE (APERTURE OF EQUAL TO OR | 100% | 100% | 100% |
| LARGER THAN 0.5 mm) (% BY WEIGHT) | | | |
| WATER ABSORPTION RATE (%) | 488% | 515% | 482% |
| COMPRESSIVE SYNERESIS RATE (%) | 21% | 13% | 15% |
| STICKINESS REDUCTION EFFECT | ⊚ | ◯ | ◯ |
| ABSENCE OF DRY TEXTURE | ⊚ | ⊚ | ⊚ |
| FLAVOR | ⊚ | ⊚ | ⊚ |
| OVERALL EVALUATION FOR SENSORY | ⊚ | ◯ | ◯ |

### Examples 21 to 27 and Comparative Example 10

Raw materials were blended according to the formulation as shown in Table 8, and granular materials were produced according to the method described in Example 1. The results of the evaluations for the obtained granular materials are shown in Table 9. Here, in the formulation 25 in Table 8, an acid-untreated high amylose corn starch was employed in place of the acid-treated high amylose corn starch.

TABLE 8

| | | | FOR- | FOR- | FOR- | FOR- | FOR- | FOR- | FOR- | FOR- |
|---|---|---|---|---|---|---|---|---|---|---|
| | | FORMULA- | MULA- | MULA- | MULA- | MULA- | MULA- | MULA- | MULA- | MULA- |
| | | TION 25 | TION 26 | TION 27 | TION 28 | TION 29 | TION 5 | TION 30 | TION 31 | TION 32 |
| FORMULATION | ACID | 20 | 20 | 20 | 20 | 20 | 20 | 20 | 20 | 20 |
| (% BY WEIGHT) | DEGRADATION- | | | | | | | | | |
| | TREATED | | | | | | | | | |
| | HIGH AMYLOSE | | | | | | | | | |
| | CORN STARCH | | | | | | | | | |
| | ACID | 0 h | 2 h | 4 h | 6 h | 10 h | 16 h | 20 h | 24 h | 30 h |
| | TREATMENT | | | | | | | | | |
| | TIME | | | | | | | | | |
| | PEAK | 214523 | 51679 | 38826 | 29138 | 24046 | 12204 | 9128 | 6184 | 5107 |
| | MOLECULAR | (UN- | | | | | | | | |
| | WEIGHT | DEGRADED) | | | | | | | | |
| | CORN STARCH | 79 | 79 | 79 | 79 | 79 | 79 | 79 | 79 | 79 |
| | CALCIUM | 1 | 1 | 1 | 1 | 1 | 1 | 1 | 1 | 1 |
| | CARBONATE | | | | | | | | | |

| AMYLOSE CONTENT | 70% | | | | | | | | |
|---|---|---|---|---|---|---|---|---|---|
| (% BY WEIGHT) OF PARTIALLY | | | | | | | | | |
| DEGRADED HIGH AMYLOSE | | | | | | | | | |
| STARCH IN RAW STARCH (A) | | | | | | | | | |
| BLENDING QUANTITY | 0% | 20% | 20% | 20% | 20% | 20% | 20% | 20% | 20% |
| (% BY WEIGHT) OF PARTIALLY | | | | | | | | | |
| DEGRADED STARCH IN | | | | | | | | | |
| GRANULAR MATERIAL (B) | | | | | | | | | |
| (A) × (B) | 0 | 1400 | 1400 | 1400 | 1400 | 1400 | 1400 | 1400 | 1400 |

TABLE 9

| | COM- | | | | | | | | |
|---|---|---|---|---|---|---|---|---|---|
| | PARA- | | | | | | | | |
| | TIVE | | | | | | | | |
| | EXAM- | EXAM- | EXAM- | EXAM- | EXAM- | FORMULA- | EXAM- | EXAM- | EXAM- |
| | PLE 10 | PLE 21 | PLE 22 | PLE 23 | PLE 24 | TION 5 | PLE 25 | PLE 26 | PLE 27 |
| FORMULATION | FOR- | FOR- | FOR- | FOR- | FOR- | FOR- | FOR- | FOR- | FOR- |
| | MULA- | MULA- | MULA- | MULA- | MULA- | MULA- | MULA- | MULA- | MULA- |
| | TION 25 | TION 26 | TION 27 | TION 28 | TION 29 | TION 5 | TION 30 | TION 31 | TION 32 |
| PARTICLE SIZE (APERTURE | 100% | 100% | 100% | 100% | 100% | 100% | 100% | 100% | 100% |
| OF EQUAL TO OR LARGER | | | | | | | | | |
| THAN 0.5 mm) (% BY WEIGHT) | | | | | | | | | |
| WATER ABSORPTION RATE (%) | 567% | 670% | 687% | 666% | 649% | 488% | 511% | 513% | 553% |
| COMPRESSIVE SYNERESIS | N.D. | 8% | 13% | 19% | 22% | 21% | 27% | 17% | 18% |
| RATE (%) | | | | | | | | | |
| STICKINESS REDUCTION EFFECT | X | Δ | ◯ | ◯ | ⊚ | ⊚ | ⊚ | Δ | Δ |
| ABSENCE OF DRY TEXTURE | ⊚ | ⊚ | ⊚ | ⊚ | ⊚ | ⊚ | ⊚ | ⊚ | ⊚ |
| FLAVOR | ⊚ | ⊚ | ⊚ | ⊚ | ⊚ | ⊚ | ⊚ | ⊚ | ⊚ |
| OVERALL EVALUATION | X | Δ | ◯ | ◯ | ⊚ | ⊚ | ⊚ | ◯ | Δ |
| FOR SENSORY | | | | | | | | | |

### Examples 28 to 31

Raw materials were blended according to the formulation as shown in Table 10, and granular materials were produced according to the method described in Example 1. The results of the evaluations for the obtained granular materials are shown in Table 11.

TABLE 10

| | | FORMULA- | FORMULA- | FORMULA- | FORMULA- | FORMULA- |
|---|---|---|---|---|---|---|
| | | TION 5 | TION 33 | TION 34 | TION 35 | TION 36 |
| FORMULATION | ACID-TREATED HIGH | 20 | 20 | 20 | 20 | 20 |
| (% BY WEIGHT) | AMYLOSE CORN STARCH | | | | | |
| | CORN STARCH | 79 | | | | |
| | WHEAT STARCH | | 79 | | | |
| | POTATO STARCH | | | 79 | | |
| | TAPIOCA STARCH | | | | 79 | |
| | CROSS-LINKED | | | | | 79 |
| | TAPIOCA STARCH | | | | | |
| | CALCIUM CARBONATE | 1 | 1 | 1 | 1 | 1 |

| AMYLOSE CONTENT (% BY WEIGHT) OF | 70% | | | | |
|---|---|---|---|---|---|
| PARTIALLY DEGRADED STARCH | | | | | |
| IN RAW STARCH (A) | | | | | |
| BLENDING QUANTITY (% BY WEIGHT) OF | 20% | 20% | 20% | 20% | 20% |
| PARTIALLY DEGRADED STARCH IN | | | | | |
| GRANULAR MATERIAL (B) | | | | | |
| (A) × (B) | 1400 | 1400 | 1400 | 1400 | 1400 |

TABLE 11

| | EXAMPLE 3 | EXAMPLE 28 | EXAMPLE 29 | EXAMPLE 30 | EXAMPLE 31 |
|---|---|---|---|---|---|
| FORMULATION | FORMULATION | FORMULATION | FORMULATION | FORMULATION | FORMULATION |
| | 5 | 33 | 34 | 35 | 36 |
| PARTICLE SIZE (APERTURE OF EQUAL TO OR | 100% | 100% | 100% | 100% | 100% |
| LARGER THAN 0.5 mm) (% BY WEIGHT) | | | | | |
| WATER ABSORPTION RATE (%) | 488% | 487% | 514% | 426% | 426% |
| COMPRESSIVE SYNERESIS RATE (%) | 21% | 28% | 12% | 9% | 13% |
| STICKINESS REDUCTION EFFECT | ⊚ | ⊚ | ◯ | ◯ | ◯ |
| ABSENCE OF DRY TEXTURE | ⊚ | ◯ | ⊚ | ⊚ | ⊚ |
| FLAVOR | ⊚ | ⊚ | ⊚ | ⊚ | ⊚ |
| OVERALL EVALUATION FOR SENSORY | ⊚ | ◯ | ◯ | ◯ | ◯ |

### Examples 32 and 33

Raw materials were blended according to the formulation as shown in Table 12, and granular materials were produced according to the method described in Example 1. The results of the evaluations for the obtained granular materials are shown in Table 13.

TABLE 12

| | | FORMU- | FORMU- | FORMU- |
|---|---|---|---|---|
| | | LATION | LATION | LATION |
| | | 37 | 5 | 38 |
| COMPONENT | ACID-TREATED | 20 | 20 | 20 |
| (% BY | HIGH AMYLOSE | | | |
| WEIGHT) | CORN STARCH | | | |
| | CORN STARCH | 80 | 79 | 78.7 |
| | EMULSIFYING | | | 0.3 |
| | AGENT | | | |
| | CALCIUM | | 1 | 1 |
| | CARBONATE | | | |

| AMYLOSE CONTENT | 70% | | |
|---|---|---|---|
| (% WEIGHT) OF PARTIALLY | | | |
| DEGRADED STARCH | | | |
| IN RAW STARCH (A) | | | |
| BLENDING QUANTITY | 20% | 20% | 20% |
| (% BY WEIGHT) OF PARTIALLY | | | |
| DEGRADED STARCH IN | | | |
| GRANULAR MATERIAL (B) | | | |
| (A) × (B) | 1400 | 1400 | 1400 |

TABLE 13

| | EXAMPLE | EXAMPLE | EXAMPLE |
|---|---|---|---|
| | 32 | 3 | 33 |
| FORMULATION | FORMU- | FORMU- | FORMU- |
| | LATION 37 | LATION 5 | LATION 38 |
| PARTICLE SIZE | 100% | 100% | 100% |
| (APERTURE OF EQUAL | | | |
| TO OR LARGER THAN | | | |
| 0.5 mm) (% BY WEIGHT) | | | |
| WATER ABSORPTION | 421% | 488% | 624% |
| RATE (%) | | | |
| COMPRESSIVE | 22% | 21% | 29% |
| SYNERESIS RATE (%) | | | |
| STICKINESS REDUCTION | ⊚ | ⊚ | ⊚ |
| EFFECT | | | |
| ABSENCE OF DRY | ⊚ | ⊚ | ◯ |
| TEXTURE | | | |
| FLAVOR | ⊚ | ⊚ | ⊚ |
| OVERALL EVALUATION | ⊚ | ⊚ | ◯ |
| FOR SENSORY | | | |

According to Table 12 and Table 13, the addition of calcium carbonate, which is one of insoluble salts, allows stabilizing the cell structure of the granular material to achieve improved production stability. An influence on the functionality of the particles was not found.

Further, the blending of the emulsifying agent allows adjustment of the hardness of the granular material, such that the eating-texture can be suitably changed according to the food or the like, to which the emulsifying agent is blended.

### Examples 34 and 35

Raw materials were blended according to the formulation 5 as shown in Table 1, and granular materials were produced in accordance with the method described in Example 1, except the conditions as shown in Table 14. The results of the evaluations for the obtained granular materials are also shown in Table 14 together.

According to Table 14, sufficient effects were able to be obtained in any cases that the degree of gelatinization of starch in the granular material is from 25% to 60%.

TABLE 14

| | EXAMPLE 3 | EXAMPLE 34 | EXAMPLE 35 |
|---|---|---|---|
| FORMULATION | FORMULATION 5 | FORMULATION 5 | FORMULATION 5 |

EXTRUDER PROCESSING CONDITIONS

| | | | |
|---|---|---|---|
| ADDITION OF WATER (%) | 12% | 20% | 10% |
| BARREL 1 TEMPERATURE (° C.) | 60 | 50 | 60 |
| BARREL 2 TEMPERATURE (° C.) | 100 | 80 | 110 |
| BARREL 3 TEMPERATURE (° C.) | 130 | 110 | 140 |
| OUTLET TEMPERATURE (° C.) | 125 | 105 | 130 |
| DEGREE OF GELATINIZATION OF STARCH | 55% | 25% | 60% |
| IN GRANULAR MATERIAL | | | |

NATURE OF PARTICLES

| | | | |
|---|---|---|---|
| PARTICLE SIZE (APERTURE OF EQUAL TO OR | 100% | 100% | 100% |
| LARGER THAN 0.5 mm) (% BY WEIGHT) | | | |
| WATER ABSORPTION RATE (%) | 488% | 262% | 512% |
| COMPRESSIVE SYNERESIS RATE (%) | 21% | 18% | 23% |
| STICKINESS REDUCTION EFFECT | ⊚ | ⊚ | ⊚ |
| ABSENCE OF DRY TEXTURE | ⊚ | ⊚ | ⊚ |
| FLAVOR | ⊚ | ⊚ | ⊚ |
| OVERALL EVALUATION FOR SENSORY | ⊚ | ⊚ | ⊚ |

### Example 36

### Preparation of Cooked Minced Meat (“Soboro”)

Cooked minced meat (“soboro”) was prepared according to the recipe shown in Table 15. First of all, water of a weight of 3 times of the granular material of Example 3 was added thereto, and was dipped at a room temperature for 1 hour. 25 parts of water-absorbed granular material was mixed with 75 parts of commercially available ground beef and pork and 0.7 part salt and 0.3 part pepper were added thereto, and then cooking was carried out with a heat at 200 degrees C. for 2 minutes while moderately stirring so as to prevent the meat from being bound to be lumped during the heating. The cooked minced meat thus obtained exhibited suppressed drip of the bouillon and enhanced eating-texture without deteriorating the eating-texture that the meat original has.

TABLE 15

| | FORMULATION |
|---|---|
| MATERIALS | (PART BY WEIGHT) |
| GROUND BEEF AND PORK | 75 |
| GRANULAR MATERIAL OF EXAMPLE 3 | 25 |
| (REHYDRATED PRODUCT WITH WATER | |
| OF 3 TIMES THEREOF) | |
| SALT | 0.7 |
| PEPPER | 0.3 |

### Example 37

### Preparation of Beef and Pork Hamburg Steak

A beef and pork hamburg steak was prepared in accordance with the recipe shown in Table 16. First of all, a beef extract seasoning (commercially available from Fuji Foods Corporation, Beefex 4% solution) of a weight of 4 times of the granular material of Example 3 was added thereto, and the granular material was dipped at a room temperature for 1 hour. 25 parts of the water-absorbed granular material was added to other materials that had been preliminarily mixed well, and these were well kneaded once again. Subsequently, each of 50 g of a flat dough (patty) was prepared by die-punching the kneaded dough, and each side of the flat dough surfaces was fried with a frying pan at 230 degrees C. for 1 minute each, and then the dough was steamed by employing a steam oven at 250 degrees C. for 5 minutes. The beef and pork hamburg steak thus prepared exhibited suppressed drip of the bouillon, and was a fluffy hamburg steak with enhanced eating-quality without strange flavor.

TABLE 16

| | FORMULATION |
|---|---|
| | (PART BY |
| MATERIALS | WEIGHT) |
| GROUND BEEF AND PORK | 44.8 |
| ONION | 17 |
| EDIBLE OIL | 12 |
| BREAD CRUMBS | 14 |
| STARCH | 8 |
| GRANULAR MATERIAL OF EXAMPLE 3 | 25 |
| (REHYDRATED PRODUCT WITH | |
| SEASONING SOLUTION OF 4 TIMES THEREOF) | |
| SUGAR | 1 |
| SALT | 0.7 |
| Na GLUTAMATE | 0.3 |
| PEPPER | 0.2 |
| WATER | 2 |

### Example 38

### Preparation of a Meat Shao-Mai

A meat shao-mai was prepared in accordance with the formulation shown in Table 17. First of all, a pork extract seasoning (commercially available from OCI Co., Ltd., bouillon mecs premium, 1% solution) of a weight of 4 times of the granular material of Example 3 was added thereto, and was dipped at a room temperature (about 30 degrees C.) for 30 minutes. 20 parts of the water-absorbed granular material was added to other materials that had been preliminarily mixed well, and these were well kneaded once again. Subsequently, each of 12 g of the kneaded dough was wrapped with a skin of dumpling and was steamed with a steam oven at 90 degrees C. for 10 minutes. The meat shao-mai thus prepared was fluffy without strange flavor and provided tender eating-texture even when it became cold.

TABLE 17

| | FORMULATION |
|---|---|
| | (PART BY |
| MATERIALS | WEIGHT) |
| GROUND PORK | 52.5 |
| ONION (MINCED) | 25.0 |
| KATAKURIKO (POTATO STARCH) | 5.5 |
| WHEAT FLOUR | 5.0 |
| SOY SAUCE | 2.5 |
| SHIITAKE MUSHROOM | 6.0 |
| (DRIED, REHYDRATED WITH WATER) | |
| SALT AND PEPPER | 1.2 |
| GINGER | 1.0 |
| SESAME OIL | 0.8 |
| SUGAR | 0.5 |
| GRANULAR MATERIAL OF EXAMPLE 3 | 20.0 |
| (REHYDRATED PRODUCT WITH | |
| SEASONING SOLUTION OF 4 TIMES THEREOF) | |

### Example 39

### Preparation of Vienna Sausage

A sausage was prepared in accordance with the formulation shown in Table 18. First of all, a pork extract seasoning (commercially available from OCI Co., Ltd., bouillon mecs premium, 1% solution) of a weight of 4 times of the granular material of Example 3 was added thereto, and was dipped at a room temperature (about 30 degrees C.) for 30 minutes. In the meantime, the raw materials except the granular material of Example 3 were mixed well, and the mixing was carried out with a hand mixer while being cooled with ice, until uniform emulsified dough was obtained. 8 parts of the water-absorbed granular material of Example 3 was added to the mixed dough, and these were well kneaded once again. Subsequently, casing in sheep intestine was carried out, and the stuffed casing was dried within an oven at 50 degrees for 30 minutes, and then was boiled in a hot water bath of 70 degrees C. for 30 minutes. The Vienna sausage thus prepared exhibited enhanced eating-texture without deteriorating the resilient texture that the meat original has.

TABLE 18

| | FORMULATION |
|---|---|
| | (PART BY |
| MATERIALS | WEIGHT) |
| GROUND PORK SHOULDER | 63.25 |
| LARD | 3.0 |
| MIZUAME (STARCH SYRUP) | 4.5 |
| POTATO STARCH | 5.0 |
| SALT | 2.0 |
| MILK PROTEIN | 2.0 |
| CRACKED PEPPER | 0.27 |
| PEPPER | 0.17 |
| POWDERED NUTMEG | 0.27 |
| POWDERED GINGER | 0.27 |
| POWDERED GARLIC | 0.27 |
| ICE WATER | 11.0 |
| GRANULAR MATERIAL OF EXAMPLE 3 | 8.0 |
| (REHYDRATED PRODUCT WITH | |
| SEASONING SOLUTION OF 4 TIMES THEREOF) | |

The present patent application claims priority on the basis of Japanese Patent Application No. 2012-084533 filed on Apr. 3, 2012, the whole contents of which are herein incorporated by reference.

1. A granular material comprising equal to or larger than 45% by weight of a starch,
the starch comprising a starch composed of one, two or more types of partially degraded starch(es) produced by treating a starch comprising amylose at a content of equal to or larger than 5% by weight with any one, two or more of an acid treatment, an oxidation treatment and an enzymatic treatment, at equal to or larger than 7% by weight in the granular material,
wherein a water absorption rate, in which the granular material absorbs water for 1 hour at 30 degrees C. by adding 40 g of water to 5 g of the granular material, is equal to or larger than 250% by weight and equal to or smaller than 700% by weight,
wherein a compressive syneresis rate, in which a water-absorbed dough that absorbs water for 1 hour at 30 degrees C. by adding 40 g of water to 5 g of the granular material is compressed at a pressure of 141.5 g/cm² at 30 degrees C. for 10 minutes, is equal to or higher than 7% by weight, and
wherein a content of particles over a sieve of 0.5 mm aperture in the granular material is equal to or larger than 40% by weight and equal to or smaller than 100% by weight.

2. The granular material according to claim 1, wherein a product obtainable by multiplying an amylose content (% by weight) in a raw starch of the starch composed of one, two or more types of the partially degraded starch(es) with a blending quantity (% by weight) in the granular material of the starch composed of one, two or more of the partially degraded starch(es) is equal to or higher than 5×10² and equal to or lower than 3×10³.

3. The granular material according to claim 1, wherein a peak molecular weight of the starch composed of one, two or more types of the partially degraded starch(es) is equal to or higher than 5×10³ and equal to or lower than 8×10⁴.

4. The granular material according to claim 1, wherein one, two or more selected from the group consisting of a corn starch, a wheat starch, a potato starch, a tapioca starch and a cross-linked starch is comprised as a starch except the starch composed of one, two or more types of the partially degraded starch(es).

5. The granular material according to claim 1, wherein a degree of gelatinization of the starch in the granular material determined by a β-amylase pullulanase (BAP) method is equal to or higher than 20%.

6. A method for producing the granular material according to claim 1, comprising:
a step for granulating a raw material comprising the starch composed of one, two or more types of the partially degraded starch(es) by heating and compressing with an extruder.

7. A food comprising the granular material according to claim 1.

8. A forage comprising the granular material according to claim 1.

9. An edible meat product comprising the granular material according to claim 1.
